(19) United States
(12) Patent Application Publication
(10) Pub. No.: US 2010/0287936 A1
(43) Pub. Date: Nov. 18, 2010

(54) THERMODYNAMIC MACHINE, PARTICULAR OF THE CARNOT AND/OR STIRLING TYPE

(76) Inventor: Serge Klutchenko, Massy (FR)

Correspondence Address: GREER, BURNS & CRAIN, 300 S WACKER DR, 25TH FLOOR, CHICAGO, IL, 60606, US

(21) Appl. No.: 12/746,631

(22) PCT Filed: Dec. 5, 2008
(86) PCT No.: PCT/FR2008/001709

§ 371 Date: Jun. 7, 2010

(30) Foreign Application Priority Data
Dec. 5, 2007 (FR) 0759590

(51) Int. Cl. F02C 1/04

(52) U.S. Cl. 60/682

(57) ABSTRACT

A thermodynamic machine including an enclosure containing a working gas and having heat exchange surfaces therein, displacement structure moveable within the enclosure in order to displace the working gas in the enclosure and consecutively place the working gas in contact and out of contact with each of the heat exchange surfaces in order to perform consecutive stages of a thermodynamic cycle; and a mechanical power unit subject to pressure of the working gas, the displacement structure causes consecutive passage of a chamber in front of the different heat exchange surfaces, the chamber containing a quantity of working gas that is essentially constant, at least the majority of which is generally stationary in relation to the displacement structure.

The present invention relates to a thermodynamic machine, in particular of the Carnot and/or Stirling type. Such a machine is typically a motor, but it can also be designed to operate as a heat pump or as a refrigerating machine.

The present invention relates more particularly to the essentially volumetric machines in which a gas is displaced in order to place it in contact with a hot heat exchange surface and a cold heat exchange surface.

In the case of a motor, the hot heat exchange surface is supplied with calories originating from an external hot reservoir. By its contacts with exchange surfaces having consecutively different temperatures, the gas undergoes temperature variations that cause pressure variations. A piston executes a power stroke when the pressure is high and a compression stroke when the pressure is low.

In the case of a heat pump or refrigerating machine, mechanical energy is supplied to the piston in order to compress the gas and thus to heat it when it is in contact with the hot heat exchange surface and/or in order to expand the gas when it is in contact with the cold heat exchange surface. Thus, the gas heats a hot reservoir linked to the hot heat exchange surface and/or cools a cold reservoir linked to the cold heat exchange surface.

Generally, it is desired that the thermodynamic cycle executed by the machine is as close as possible to a theoretical cycle. For a Carnot type machine the theoretical cycle consecutively comprises a slow isothermal compression at the temperature of the cold reservoir, a rapid adiabatic compression, a slow isothermal expansion at the temperature of the hot reservoir, and a rapid adiabatic expansion.

Such a cycle has a theoretical yield equal to one minus the ratio between the absolute temperature of the cold reservoir and the absolute temperature of the hot reservoir. This cycle has the advantage of allowing the exploitation of small temperature differences between the hot reservoir and the cold reservoir. However, it is not well suited to large temperature differences between the reservoirs, as it then requires high pressure variations, and therefore a high-displacement piston.

For a machine of the Stirling type, the theoretical cycle consecutively comprises an isothermal compression at the temperature of the cold reservoir, an isochoric heating, an isothermal expansion at the temperature of the hot reservoir, and an isochoric cooling. As the compression and expansion are carried out at a constant temperature, the heating and cooling take place between the same two extreme temperatures, namely that of the hot reservoir and that of the cold reservoir respectively. This makes it possible to carry out heating and cooling by exchange of calories in a heat exchanger. This is then described as heating and cooling by “regeneration”. Such a cycle has an advantageous theoretical yield, equal to the difference between the absolute temperature of the hot reservoir and the absolute temperature of the cold reservoir, divided by the absolute temperature of the hot reservoir. This cycle is therefore particularly suited to exploiting large temperature differences between the hot reservoir and the cold reservoir.

This type of machine, although theoretically very advantageous, is difficult to implement. There are several standard architectures in which at least one “displacer” (a sort of piston) displaces the working gas from the hot heat exchange surface to the cold heat exchange surface via a conduit in which the heat exchanger or “regenerator” is installed. The yield of such machines is greatly inferior to the theoretical yield of the previously described Stirling cycle. During operation, the conduit, the regenerator and other inner volumes constitute dead volumes, the total value of which is considerable by comparison with the volume of gas which, for example, is effectively in contact with the hot heat exchange surface during expansion in the case of a prime mover. Moreover, such gas circulations generate pressure losses and thermal losses.

The purpose of the present invention is thus to propose a novel thermodynamic machine that reduces the impact of all or part of the above mentioned drawbacks, and/or that is capable of operating according to at least one of the actual cycles that are closer to the desired theoretical cycles.

According to the invention, the thermodynamic machine comprising:
an enclosure containing a working gas and having inner heat exchange surfaces;
displacement means moveable within the enclosure in order to displace the working gas in the enclosure and consecutively place the working gas in and out of contact with each of the heat exchange surfaces in order to perform the consecutive stages of a thermodynamic cycle; and
a mechanical power component subject to the pressure of the working gas;
   is characterized in that the displacement means cause consecutive passage of a chamber in front of the different heat exchange surfaces, said chamber containing a quantity of working gas that is essentially constant, at least the majority of which is generally stationary in relation to the displacement means. An indirect coupling allows a crankshaft receiving the motive force of the mechanical power component to rotate at least temporarily at a speed of rotation different to that of a shaft controlling the movement of the displacement means

Thus, according to the invention, instead of driving the working gas from one chamber to the other for each stage of the cycle, the working gas permanently occupies a chamber that passes in front of the different heat exchange surfaces.

It is thus possible to severely reduce or even almost eliminate the dead volumes or also the pressure losses linked to the gas flow and/or significantly reduce the thermal losses.

In the machine according to the invention, the whole quantity of gas present in the chamber performs a clearly defined phase of its thermodynamic cycle, in contact with a clearly defined heat exchange surface. This makes it possible to clearly break down the thermodynamic cycle in the machine into phases that are much closer than in the past to those of the desired theoretical cycle. The yield per cycle is therefore improved. This allows for machines to be produced that operate efficiently with very small temperature differences, for example with less than 100° K difference between the hot reservoir and the cold reservoir.

Preferably, the substantially constant quantity of gas is a constant volume. In this case, the chamber can be in permanent communication with a variable volume cavity, for example a cylinder, in which the mechanical power component, such as a piston, is displaced.

It can also be envisaged for the chamber itself to have a variable volume. In this case, the mechanical power component can be constituted by all or part of the displacement means.

Preferably, the displacement means include a rotor, mobile around an axis. Thus, the heat exchange surfaces can be distributed around the axis. The rotor drives the chamber in rotation so that it coincides consecutively with the different exchange surfaces.

Typically, the displacement means include two faces substantially facing each other in order to delimit the chamber. The chamber then has for example the shape of a cavity formed in the displacement means and the open surfaces of which pass in front of the different heat exchange surfaces integral with the enclosure. Other configurations are possible. For example, when the displacement means comprise a rotor, the chamber can be defined by a single face of the displacement means, in particular a flat on the lateral surface of the rotor rotating in a cylindrical enclosure.

The heat exchange surfaces can comprise heat-carrier exchange surfaces i.e. the exchange surfaces already mentioned previously linked to hot or cold reservoir. The machine can also comprise means of thermal containment capable of restricting the heat exchanges with the working gas.

An original idea of the invention consists of having produced a machine of the Carnot type in which the displacement means pass through the region of the thermal containment means. These are located in the main enclosure such that there is within the enclosure at least one thermal containment surface intercalated between the exchange surfaces. Conversely, in the prior art, the displacement means drive the gas from one chamber to another, then from the other chamber to the first, making the gas pass alternately in one direction and in the other via a conduit which is external to the main enclosure and in which the thermal containment means are located.

When the displacement means place the working gas in contact with the thermal containment means, a movement of the power component is carried out in such a way that the thermodynamic cycle comprises at least one phase of adiabatic variation of the volume of the working gas.

The Carnot thermodynamic cycle comprises the working gas passing consecutively in contact with the following surfaces:
a cold heat-carrier surface while the volume of the working gas decreases,
a thermal containment surface while the volume of the working gas decreases,
a hot heat-carrier surface while the volume of the working gas increases,
a thermal containment surface while the volume of the working gas increases.

Preferably the variation in the volume is quicker while the working gas is in contact with the containment surfaces than while the gas is in contact with the heat-carrier exchange surfaces. The gas in contact with the heat-carrier surfaces must carry out a heat transfer the speed of which depends in particular on the thermal inertia of the materials and of the exchange surfaces. Conversely, in order to minimize the thermal exchanges and shorten the duration of the cycle, it is advantageous to rapidly vary the volume of the working gas, and therefore the temperature, while the gas is in contact with the containment surfaces.

Thus when the working gas is in contact with a containment surface, a temperature variation is caused by substantially adiabatic variation of the working gas in the same direction as that experienced by the working gas on contact with the regeneration surface situated upstream.

The heat exchange surfaces can also comprise regeneration exchange surfaces intercalated between the heat-carrier exchange surfaces.

An original idea of the invention consists of having produced a machine of the Stirling type in which the displacement means pass through the region of the regeneration means, which are located in the main enclosure. Conversely, in the prior art, the displacement means drive the gas from one chamber to another, then from the other chamber to the first, making the gas pass alternately in one direction and in the other via a conduit which is external to the main enclosure and in which the regeneration means are located.

According to the invention, the regeneration exchange and/or containment surfaces are positioned in order to delimit a part of the route of the mobile chamber being displaced with the displacement means. A machine according to the invention can be designed in order to simultaneously operate several thermodynamic cycles that are identical but out of phase so that the heating of a cycle by regeneration is fed with calories supplied by the cooling of the gas in another cycle, and/or the piston compressing the gas for the adiabatic heating is driven by the energy supplied by the piston expanding the gas for the adiabatic cooling.

The transfer of calories by the regeneration exchange surfaces can take place by thermal conduction, or by an intermediate circulating fluid, or also by means of an intermediate thermal reserve which in a steady state adopts a desired equilibrium temperature.

It is also possible to avoid heat transfers between out-of-phase cycles. To this end, the heat collected during the cooling of the gas is stored in a thermal reserve in order to be given back during a subsequent re-heating of gas. If the chamber is displaced in a reciprocating movement, a regeneration surface can be both a heating surface in a direction of movement of the chamber and a cooling surface in the other direction of movement of the chamber. If the movement of the chamber is a continuous rotation, the regeneration exchange surfaces are specialized for heating or cooling respectively and heat transfer means are provided between them. The transfer can take place in the direction of rotation, or also in the opposite direction. It is also possible, as will be seen later in the description of an example, to advantageously combine transfers in both directions in a single machine. From the standpoint of the transfer of calories, the transfer takes place from in front of to behind a cold heat-carrier exchange surface, and from behind to in front of a hot heat-carrier exchange surface, in relation to the direction of movement of the chamber. From the standpoint of the transfer of frigories, the directions of transfer are the reverse of those described above for calories.

It is also possible according to the invention to operate a hybrid Carnot-Stirling thermodynamic cycle when there is a thermal containment surface between a regeneration surface situated upstream with respect to the direction of displacement of the working gas, and a heat-carrier exchange surface situated downstream.

The hybrid cycle according to the invention comprises the passing of the gas in contact with the following surfaces for a motor cycle:
a cold heat-carrier surface while the volume of the gas decreases,
a regeneration heating surface while the volume of the working gas is substantially constant,
a thermal containment surface while the volume of the working gas decreases,
a hot heat-carrier surface while the volume of the gas increases,
a regeneration cooling surface while the volume of the working gas is substantially constant,
a thermal containment surface while the volume of the working gas increases.

For a heat pump cycle the gas travels the reverse path and the direction of volume variation associated with each surface other than the two regeneration surfaces must also be reversed.

A further original idea on which the invention is based consists of considerably increasing the surface area of the heat exchange surfaces by comparison with the cylindrical surfaces, swept by circular pistons, of the state of the art. According to this aspect of the invention, the chamber is given a flattened shape, the large faces of which constitute the heat exchange surfaces, while at least one of the small faces is constituted by a front face of the displacement means.

Preferably, the heat exchange surfaces are formed on fins forming individual chambers between them. The lateral faces of the fins constitute the large faces of these chambers. The displacement means comprise flanges which pass between the fins. Each flat chamber has at least one narrow face constituted by the front face, i.e. the anterior or posterior face in relation to the direction of movement, of a flange of the displacement means.

The invention also relates to a method for the conversion of energy between the thermal form and the mechanical form, in which during a thermodynamic cycle thermal energy is removed from a working gas during isochoric cooling and this thermal energy is supplied to the working gas during isochoric heating, characterized in that the isochoric cooling and/or the isochoric heating is adjacent on the one side to a substantially adiabatic variation in the volume of the working gas and on the other side to a substantially isothermal variation in the volume of the working gas.

Other features and advantages of the invention will also become apparent from the description below, with respect to non-limitative examples.

In the attached drawings:

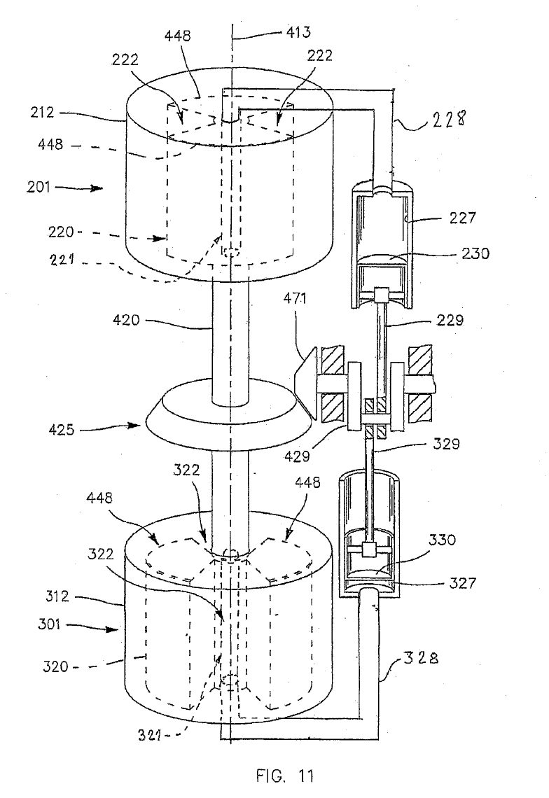

FIG. 11s a pressure-volume graph of a Stirling thermodynamic cycle;

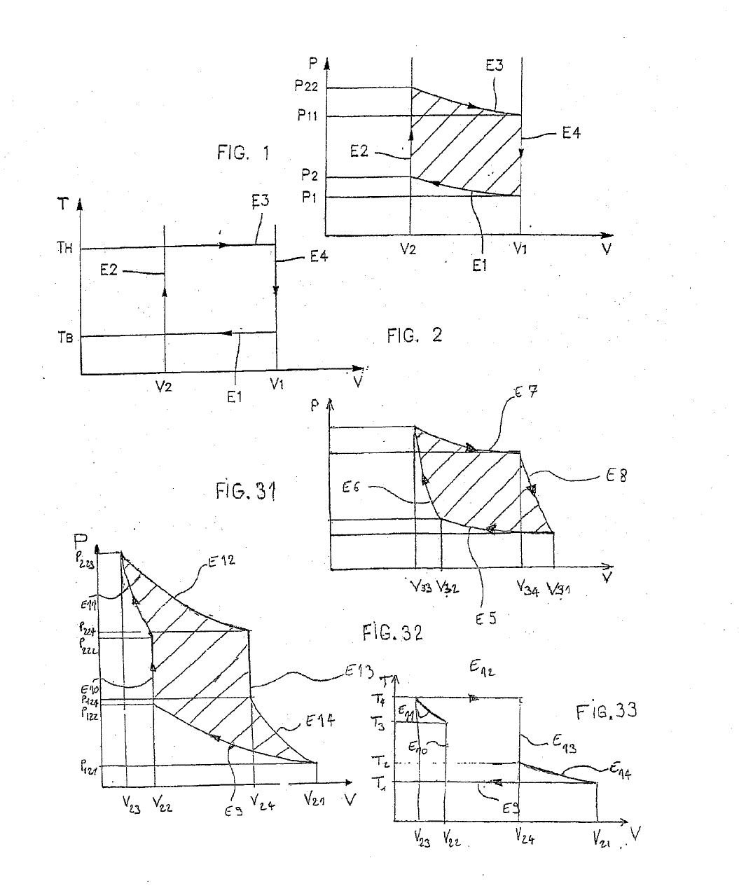

FIG. 2 is the temperature-volume graph of the cycle in FIG. 1;

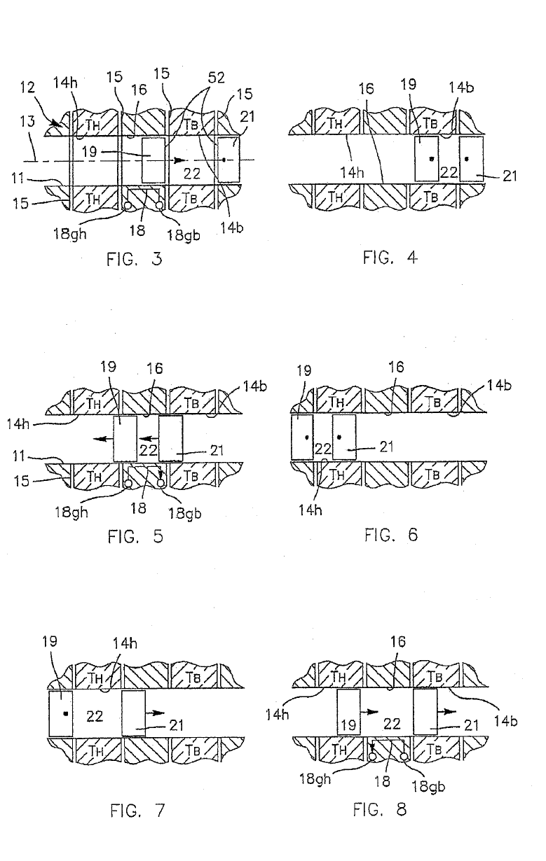

FIGS. 3 to 8 are diagrammatic representations of the principal of a machine according to the invention, at six consecutive stages of its operating cycle;

FIG. 9 is a mechanical diagram of the machine in FIGS. 3 to 8;

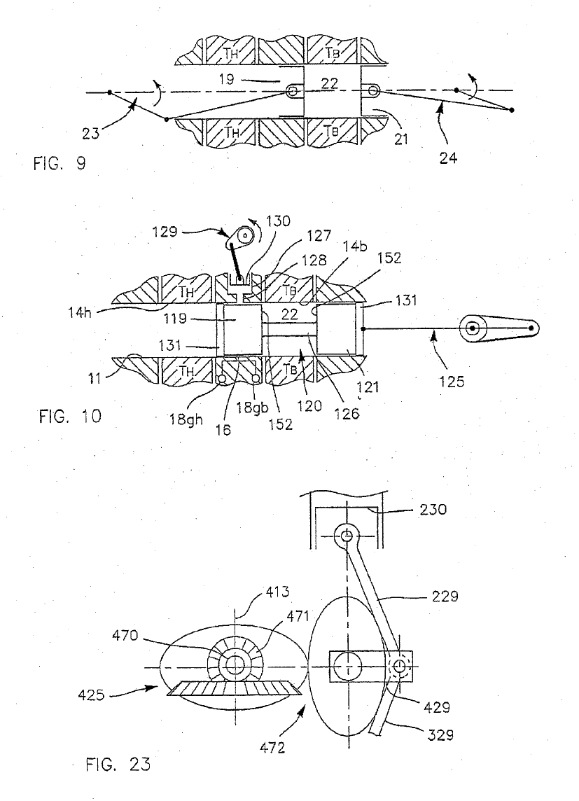

FIG. 10 is a view similar to FIG. 9 but relating to a second embodiment of the machine according to the invention;

FIG. 11 is a diagrammatic perspective view, with partial cutaway, of a third embodiment of a machine according to the invention;

FIG. 12 is a partial cross sectional view along XII-XII in FIG. 15, showing the enclosure and the displacement means of the machine in FIG. 11;

FIG. 13 is a perspective view of two superimposed stator plates, relating to a Stirling thermodynamic cycle, of the machine in FIG. 11;

FIG. 14 is a partial perspective view of the displacer of the machine in FIG. 11;

FIGS. 15 to 22 are diagrammatic views of the machine in FIG. 11 at eight consecutive stages of its operating cycle, in a cross section transverse to the axis of rotation of the displacer, the cylinder-piston assembly being shown rotated 90° for the purposes of illustration;

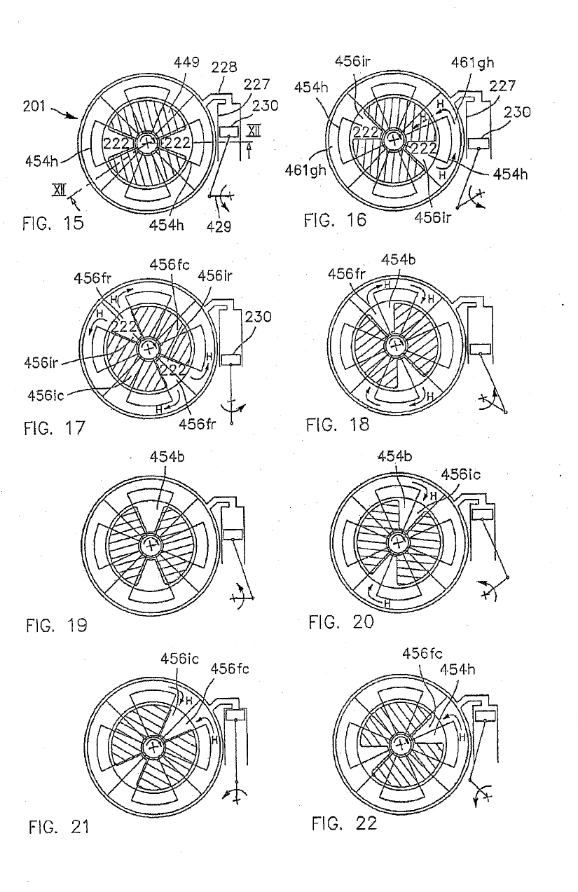

FIG. 23 shows a variant for the mechanical coupling between the displacer and the crankshaft of the machine in FIG. 11;

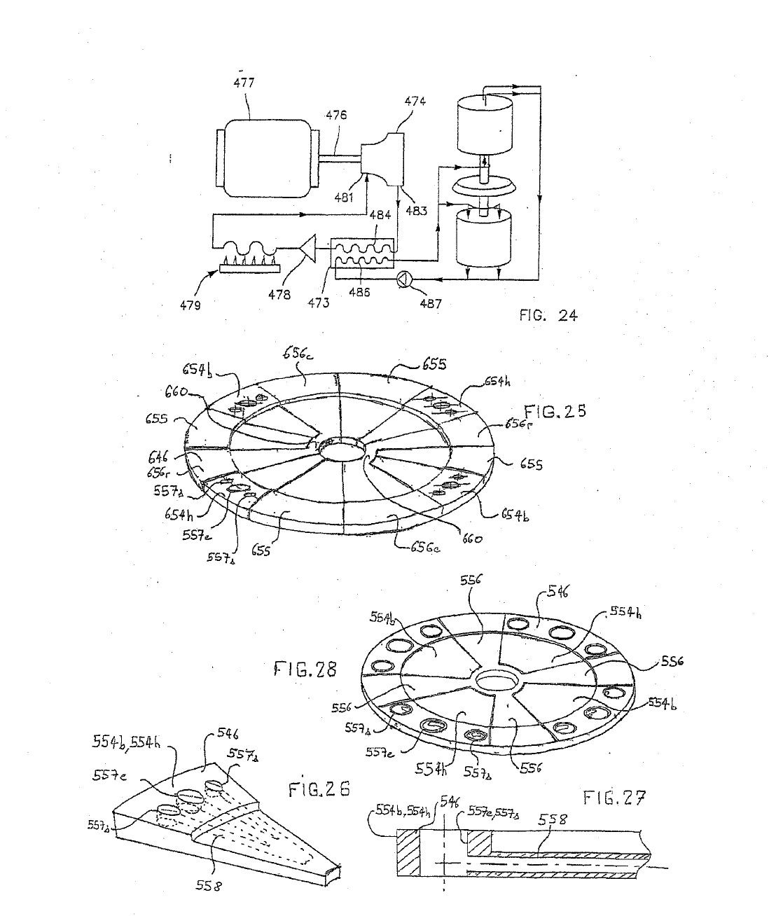

FIG. 24 is a schematic diagram showing the machine in FIG. 11 operating as a motor powered by the residual heat of a steam turbine;

FIG. 25 is a perspective view of a hybrid stator plate coupling Carnot and Stirling cycles, of the machine in FIG. 11;

FIG. 26 is a perspective view of a heat-carrier exchange surface passed through by circulation conduits;

FIG. 27 is a partial cross sectional view of a heat-carrier exchange surface;

FIG. 28 is a perspective view of a stator plate relating to a Carnot thermodynamic cycle, of the machine in FIG. 11;

FIG. 31 is a pressure-volume graph of a Carnot thermodynamic cycle;

FIG. 32 is a pressure-volume graph of a hybrid thermodynamic cycle coupling Carnot and Stirling cycles; and

FIG. 33 is a temperature-volume graph of a hybrid thermodynamic cycle coupling Carnot and Stirling cycles.

FIGS. 1 and 2 show an example of motor cycle according to a Stirling cycle. FIG. 1 shows the changes in the pressure of the working gas when it undergoes the four consecutive stages of its cycle carried out in the direction of the arrows, namely compression E1 from a maximum volume V1 to a minimum volume V2, isochoric heating E2 while the volume is kept at its minimum value V2, expansion E3 from the volume V2 to the volume V1, and isochoric cooling E4 while the volume is kept at its maximum value V1.

FIG. 2 shows the changes in the temperature of the working gas during the same Stirling cycle, still carried out in the direction of the arrows. This graph shows that the compression E1 and the expansion E3 are isothermal.

The compression E1 takes place at a constant low temperature Tb and the expansion E3 at a constant high temperature Th. According to Mariotte's law, this isothermal compression and expansion is represented in the diagram in FIG. 1 by segments of the curve of the general function P=nRT/V in which P represents the pressure, n represents the number of moles of gas, R represents the constant of the ideal gases, T represents the temperature and V represents the volume. Thus, during compression, the pressure of the working gas increases from P1 to P2, and during expansion, the pressure decreases from P22 to P11. During isochoric heating, the pressure increases from P2 to P22, and during isochoric cooling, the pressure decreases from P11 to P1. The area of the cycle hatched in FIG. 1, represents the mechanical work theoretically supplied by the cycle. It is noted that for a given volume difference V1-V2, this energy is substantially proportional to the mass of gas contained in the machine. In order to increase the work supplied by this cycle, the filling pressure can then be increased by carrying out an initial pressurization of the working gas in the machine.

In the case of operation as a heat pump or as a refrigerating machine, the same cycle can be performed, but in the other direction, opposite to that indicated by the arrows, with isothermal compression at a high temperature Th of the pressure P11 to P22, cooling at a minimum constant volume V2, expansion at a low temperature Tb of the pressure P2 to P1, and heating at a maximum constant volume V1. The area of the cycle hatched in FIG. 1 then represents the mechanical work theoretically consumed by the cycle.

In the case of the motor, as in that of the heat pump, the cooling and the heating therefore take place between identical extreme temperatures, namely from Tb to Th for heating and from Th to Tb for cooling. The Stirling cycle thus makes it possible to recover calories during cooling in order to use them during heating, and reciprocally to recover frigories during heating in order to use them during cooling. As a result, the only thermal requirements of the theoretical cycle vis-á-vis the outside are keeping the working gas in contact with a hot reservoir during the volume variation stage at the high temperature Th, and in contact with a cold reservoir during the volume variation stage at the low temperature Tb.

During the isothermal compression, the gas supplies heat to the reservoir with which it is in contact. During isothermal expansion, the gas receives heat supplied by the reservoir with which it is in contact.

FIG. 31 shows an example of a Carnot motor cycle. FIG. 31 represents the changes in the pressure of the working gas when it undergoes the four consecutive stages of its cycle carried out in the direction of the arrows, namely isothermal compression E5 from a maximum volume V31 to an intermediate volume V32, adiabatic heating E6 by compression to a minimum volume V33, isothermal expansion E7 from the volume V33 to the volume V34, and adiabatic cooling E8 while the volume increases to its maximum value V31.

In the case of operation as a heat pump or as a refrigerating machine, the same cycle can be performed, but in the other direction, opposite to that indicated by the arrows.

FIG. 32 shows an example of a hybrid motor cycle. FIG. 32 represents the changes in the pressure of the working gas when it undergoes the six consecutive stages of its cycle carried out in the direction of the arrows, namely isothermal compression E9 from a maximum volume V21 to an intermediate volume V22, isochoric heating E10 while the volume is maintained at its intermediate value V22, adiabatic heating E11 by compression to a minimum volume V23, isothermal expansion E12 from the volume V23 to the volume V24, isochoric cooling E13 while the volume is maintained at its value V24, and adiabatic cooling E14 by increasing the volume to its maximum value V21.

FIG. 33 represents the changes in the temperature of the working gas during the same hybrid cycle, still carried out in the direction of the arrows. This graph shows that the compression E9 and the expansion E12 are isothermal. The compression E9 takes place at a constant low temperature T1 and the expansion E12 at a constant high temperature T4. During isochoric heating, the pressure increases from P122 to P222, and during isochoric cooling, the pressure decreases from P224 to P124. During adiabatic heating, the pressure increases from P222 to P223, and during adiabatic cooling, the pressure drops from P124 to P121. The area of the cycle hatched in FIG. 32 represents the mechanical work theoretically supplied by the cycle. It is noted that for a given volume difference V1-V2, this energy is substantially proportional to the mass of gas contained in the machine. In order to increase the work supplied by this cycle, the filling pressure can then be increased by carrying out an initial pressurization of the working gas in the machine.

In the following, for simplification, the invention will be described only as it operates as a motor, except when explicit reference is made to its operation as a heat pump or as a refrigerating machine.

FIGS. 3 to 8 show six consecutive states of a machine according to the invention capable of carrying out an actual Stirling thermodynamic cycle similar to the cycle in FIGS. 1 and 2.

The machine comprises a bore 11 formed in a body 12 that constitutes an enclosure for this bore. In order to define the bore 11, the body 12 has consecutive heat exchange surfaces along the axis 13 of the bore. Thus there is a hot heat-carrier heat exchange surface 14h and a cold heat-carrier heat exchange surface 14b, separated by a regeneration heat exchange surface 16. The exchange surfaces are supported by elements, for example made of metal, which are separated from each other by thermal insulation 15 depicted by double lines between these elements, intended to minimize the heat leakage between them. The hot heat-carrier surface 14h is thermally coupled to the hot reservoir (not shown), while the cold heat-carrier surface 14b is thermally coupled to the cold reservoir (not shown). The regeneration heat exchange surface 16 is thermally coupled to a fluid circuit 18 extending between a hot thermal reserve 18gh and a cold thermal reserve 18gb.

Two pistons 19 and 21 are slidably mounted in a sealed manner in the bore 11. They have two front faces 52, facing each other, which between them define a chamber 22 containing a working gas. The quantity of working gas contained in the chamber 22 is essentially constant. In this example, the constant quantity is a constant mass. The pistons 19 and 21 constitute displacement means, which are displaced in synchronization with each other in order to make the chamber 22 pass consecutively in front of the different heat exchange surfaces 14h, 16, 14b and thus consecutively place the working gas in heat exchange contact with these different exchange surfaces. In order to optimize the thermal contact, each exchange surface 14h, 16 or 14b defines the whole circumference of a respective section of the bore 11. As the pistons 19 and 21 slide in the bore, their direction of movement is parallel to the exchange surfaces constituting the bore. According to a feature of the invention, the displacement means (pistons 19, 21) consecutively sweep the exchange surfaces and in particular, in a particularly remarkable manner, the regeneration exchange surface 16.

As is apparent on viewing FIGS. 3 to 8 simultaneously, the chamber 22 and the quantity of working gas that it contains are essentially stationary in relation to the two pistons 19 and 21. In other words, the two pistons 19 and 21, as well as the chamber 22 defined between them and the gas that it contains are displaced as a single entity. Of course, in this example, said entity can be deformed in the sense that the pistons are at a variable distance from each other as will be seen below. But, compared with each piston, the gas still remains on the same side of the piston, without being driven toward the other side of the piston or toward another chamber via a conduit.

In the situation shown in FIG. 3, the two pistons 19 and 21 are positioned so that the chamber 22, having its maximum volume V1, is in thermal contact with the cold heat-carrier surface 14b. The standpoint is the bottom right-hand corner of the cycle in FIGS. 1 and 2, i.e. the transition between the end of the cooling stage E4 and the start of the compression stage E1. The piston 21 delimiting the chamber 22 on the side opposite the hot heat-carrier exchange surface 14h is substantially immobile. The other piston 19 is displaced towards the piston 21 to situation shown in FIG. 4, where the two pistons 19 and 21 are substantially immobile, and the chamber 22 is at its minimum volume V2 while still being in thermal contact with the cold heat-carrier surface 14b. The heat produced by the compression has been simultaneously removed by the cold reservoir via the cold heat-carrier surface 14b. This achieves the isothermal compression E1 of the cycle in FIGS. 1 and 2. During this compression, the piston 19, which is moved, supplies mechanical energy to the gas.

In the situation shown in FIG. 5, the two pistons 19 and 21 are displaced together in the zone of the regeneration exchange surface 16, while the chamber 22 keeps its minimum volume V2. In the circuit 18, the fluid is set in motion starting from the hot reserve 18gh. The hot fluid gives up calories to the working gas via the regeneration exchange surface 16, then goes into the cold reserve 18gb. Due to these calories, the working gas passes progressively from its low temperature Tb to its high temperature Th. This achieves the isochoric heating stage E2 of the cycle.

Then, the pistons 19 and 21 bring the chamber 22, still at its minimum volume V2, in contact with the hot heat-carrier exchange surface 14h (FIG. 6), then the piston 21 changes direction of movement to move away from the piston 19 and increase the size of the chamber 22 still in thermal contact with the hot heat-carrier exchange surface 14h (FIG. 7). This achieves the isothermal expansion stage E3 of the cycle. During this expansion, the hot reservoir supplies calories to the gas via the hot heat-carrier surface 14h so that the gas remains at the high temperature Th in spite of the reduction in its pressure. During this expansion, the piston 21, which is displaced, recovers from the gas greater mechanical energy than that supplied to the gas by the piston 19 during the compression (since the stroke traveled is the same but the pressure applied to the piston is greater).

The piston 19 opposite the cold heat-carrier surface 14b, which remained substantially immobile during the expansion stage, is in turn set in motion in the direction of the cold heat-carrier surface 14b (FIG. 8) while the chamber 22, keeping its maximum volume V1 since the end of expansion, moves into a position of thermal contact with the regeneration exchange surface 16. In the circuit 18, the fluid is set in motion from the cold reserve 18gb, absorbs the calories contained in the working gas and cools the latter from the high temperature Th to the low temperature Tb then goes into the hot reserve 18gh. This achieves the isochoric cooling stage E4 of the cycle.

The process then reverts to the situation shown in FIG. 3 and the cycle already described recommences.

In this embodiment, the pistons 19 and 21 constitute both displacement means of the gas and mechanical power components subjected to the gas pressure in order to supply mechanical energy to the gas during the compression stage and recover mechanical energy from the gas during the expansion stage.

FIG. 9 shows an actuation mechanism of the pistons 19 and 21, capable at the same time of transmitting the working load of the gas. The pistons 19 and 21 are situated between two cranks 23, 24 to which they are respectively connected. The two cranks are mechanically coupled in order to rotate at the same speed but with a phase difference between them such that the piston 21 situated on the side of the cold heat-carrier exchange surface 14b is ahead of the other piston 19. The mechanical power supplied by the machine is received by a motor shaft (not shown) coupled to the two cranks, for example a drive shaft integral with one of the cranks.

In the embodiment illustrated in FIG. 10, which will be described only insofar as it differs from that in FIGS. 3 to 9, the displacement means and the mechanical power components are separate.

The displacement means comprise only a single piston 120 connected to a single crank system 125. The piston 120 is in form of a diabolo with two end bodies 119, 121 rigidly connected together by a rod 126 and between them defining the chamber 22. The constant quantity of gas contained in the chamber 22 is now a constant volume defined between two faces at 152, turned towards each other and each belonging to one of the bodies 119, 121.

A bore 127, forming a working chamber, communicates with the bore 11 through the lateral wall thereof, via a passageway 128 typically situated at the mid-distance axially between the hot heat-carrier surface 14h and the cold heat-carrier exchange surface 14b. A power piston 130 sealingly slides in the working bore 127 in order to close the latter on its side remote from the passageway 128. The piston 130 is connected to a crank-and-connecting rod system 129.

At its two opposite ends, the displacer piston 120 comprises sealing collars 131 which are a sufficient distance apart from each other for the chamber 22 to permanently communicate with the working bore 127. However, between each of the collars 131 and the connecting rod 126, the end bodies 119, 121 fill almost the entirety of the transverse section of the bore 11. As shown in FIG. 10, this makes it possible for the chamber 22 to communicate with the passage 128 while placing the very great majority of the volume of the chamber 22 in exclusive thermal contact with an exchange surface such as the cold heat-carrier exchange surface 14b (situation shown) or the hot heat-carrier exchange surface 14h (situation not shown) which is not that in which the passageway 128 opens out. The crank systems 125 and 129 are mechanically coupled to each other in order to rotate at the same speed and with a suitable orientation in relation to each other.

This orientation is such that the power piston 130 reduces the available volume for the gas in the bore 127 when the displacement piston 120 is at the end of its stroke where the chamber 22 is in thermal contact with the cold heat-carrier exchange surface 14b. This is the situation shown in FIG. 10. Its effect is to compress the gas while it is maintained at its low temperature Tb, which achieves the low temperature isothermal compression E1 already described. Next, the crank 125 displaces the displacement piston 120 toward the position of thermal contact with the regeneration exchange surface 16 then with the hot heat-carrier exchange surface 14h while the working piston 130 remains close to its position in which the available volume in the bore 127 is small, which corresponds to the isochoric heating stage E2. Then, the available volume in the bore 127 increases in size while the displacer piston 120 positions the chamber 22 in thermal contact with the hot heat-carrier exchange surface 14h. This achieves the high temperature isothermal expansion E3. Finally, the isochoric cooling stage E4 takes place when the displacer piston 120 passes in front of the regeneration exchange surface 16 toward the cold heat-carrier heat exchange surface 14b while the mechanical power piston 130 remains close to its position in which the available volume in the bore 127 is maximum.

In this embodiment, it is the power crank 129 that receives the mechanical power, while the global mechanical energy supplied or received by the displacement crank 125 actuating the displacer piston 120 is theoretically zero.

With reference to FIGS. 11 to 22 and 25 to 28 the preferred embodiment of the invention will now be described, in which the displacer is rotary. The displacer is a rotor always rotating in the same direction in the enclosure constituting a stator.

In the example shown, the machine comprises with reference to FIG. 11 two units 201, 301, the respective displacers 220, 320 of which are rigidly linked to each other by a common rotary shaft 420. Each unit 201, 301 is an elementary machine having several chambers 222, 322. Each chamber 222, 322 performs a complete thermodynamic cycle on each semi-rotation of the shaft 420 and of the displacers 220, 320. The two displacers 220, 320 are offset by 90° in relation to each other about their axis of rotation 413. The elementary machines are of the type in which the constant quantity of gas contained in each chamber is a constant volume. Each unit 201, 301 comprises an enclosure 212, 312 in the general form of a sealed cylindrical tank containing the working gas. Each enclosure 212, 312 is connected, by a passageway 228, 328, to a respective working bore 227, 327 which is closed on its side remote from the passageway 228, 328, by a power piston 230, 330. The passageway 228, 328 communicates with the chamber 222, 322 via a recess 221, 321 in the displacer 220, 320. The pistons 230, 330 are each linked by a respective connecting rod 229, 329 to a common crankshaft 429 which is coupled to the shaft 420 by a gear 425. The gear ratio is such that the shaft 420 controlling the movement of the displacers rotates at half the speed of the crankshaft 429 receiving the driving force of the machine. Thus, each working piston 230, 330 performs a full cycle (outward and return) when the displacers perform a semi-rotation and as a result each elementary machine has itself performed a full cycle. Moreover, the gear 425 establishes a suitable orientation between the displacers 220, 320 on the one hand and the crankshaft 429 on the other hand. The two pistons 230, 330 are offset by a semi-cycle in relation to each other, as are the displacers 220 and 320 in relation to each other. The phase difference of the pistons is obtained by coupling their two connecting rods 229, 329 to the same crank pin of the crankshaft 429, while the two cylinders 227, 327 are at 180° to each other about the axis of the crankshaft 429.

Each of the displacers 220, 320 comprises two lobes 448 each having the general form of a sector of a cylinder having as its axis the axis of rotation 413. The recess 221, 321 is preferably cylindrical having the axis 413.

More generally, the number of lobes 448 in each unit is equal to the number of thermodynamic cycles per rotation of the displacer. The lobes 448 are integral with each other, and allow the chambers 222, 322 to be defined in the available space between the lobes inside the enclosure. At all times, the chambers 222, 322 occupy in each enclosure angular positions offset about the axis 413 by an angle (180° in the example) which is equal to the angle to be traveled in order to perform a full thermodynamic cycle. For this reason, at each time point, all the chambers of a single enclosure perform the same stage of the thermodynamic cycle. The pressure in all the chambers of a single enclosure is therefore the same.

This preferential feature of the invention, according to which all the chambers of a single enclosure are at all times in a state of equal pressure, makes it possible according to a very advantageous improvement not to provide any sealing device between the displacer and the inner walls of the enclosure. As a result, the problems of friction and differential expansion between the displacer and the inner walls of the enclosure are significantly reduced or eliminated. Moreover, the entire interior of the tank constituting the enclosure is at the pressure of the chambers 222 or 322. The displacer is therefore not really a piston, but rather a sort of moveable body having the function, at all times, of occupying the space where the gas must not be present.

The internal structure of a unit will now be described with reference to FIGS. 12 and 14, taking as an example the unit 201.

The inner space of each enclosure is subdivided into a large number of superimposed annular passageways 422 (FIG. 12) surrounding the axis of rotation 413 and having a flattened shape parallel to a plane perpendicular to the axis of rotation 413. The passageways 422 are separated from each other by fins 441 extending radially towards the axis 413. The inner periphery 442 of the fins 441 has a small clearance with a central cylindrical core 443 of the displacer 220. The core 443 closes the passageways on the radially inner side. Each fin 441 extends over 360° about the axis 413 and belongs to a stator plate 444 in the form of disk (also see FIG. 13). The stator plates are stacked on top of each other in the enclosure. Each plate 444 has on its periphery an annular boss 446 having a set thickness corresponding to the desired thickness for each passageway 422. In the stack of plates, a flat face of each plate rests on the boss of one of the neighbouring plates. The passageways have a rectangular cross section that is the same in all axial planes.

Each of the two lobes 448 (FIG. 14) of the displacer 220 is formed of a series of flat flanges 449 in the form of a sector of a disk extending in a plane perpendicular to the axis of rotation 413. The flanges are fixed onto the central core 443. In each axial plane they have a section the form and the dimensions of which are identical, subject to operating clearance, to those of the above-mentioned cross section of the passageways. Moreover, the flanges 449 have a gap between them, substantially equal, allowing for running clearance, to the thickness of the fins 441. The radius of the radially outer edge 451 of the flanges 449 is substantially equal, allowing for running clearance, to the radius of the radially inner face 447 (FIG. 13) of the bosses 446. Each flange 449 of a lobe 448 is coplanar with a flange 449 of the other lobe. In the example shown, each flange extends over 135° about the axis of rotation 413, and as a result each elementary chamber 222 extends over 45° about the axis 413.

In the assembled condition, there is a pair of flanges 449 in each passageway. The two flanges 449 in a pair occupy all of the available space in a passageway with the exception of the two elementary chambers 222. However, the flanges 449 are not in sealed contact with the surfaces of the passageway.

Each elementary chamber 222 is delimited between two plates by a contour formed from the lateral surface of the core 443, the cylindrical inner lateral surface 447 of a boss 446, and two front faces 452 facing each other of two coplanar flanges 449 of the displacer 220.

The cylindrical central core 443 also comprises an inner aperture 500 in the form of a cylindrical bore around the axis 413. The aperture 500 communicates with each elementary chamber 222 by means of a respective opening 502 made through the cylindrical central core 443. At one end of the displacer 220, the aperture 500 also communicates with the passageway 228, 328.

The two large faces of each fin 441 as well as the inner peripheral face 447 of each boss 446 constitute the heat exchange surfaces of the machine. They extend parallel to the direction of circular displacement of the flanges 449 of the displacer.

To this end, each fin 441 is constituted of thermally conductive sectors that are consecutive in the circumferential direction with a regular alternation of cold 454b or hot 454h heat-carrier sectors and regeneration sectors 456ic,fc,ir,fr that will be detailed below. For each angular range corresponding to a thermodynamic cycle, therefore each angular range of 180° in the example, there is a cold heat-carrier sector 454b bearing a cold heat-carrier exchange surface 14b and a hot heat-carrier sector 454h bearing a hot heat-carrier exchange surface 14h. The heat-carrier sectors 454 are extended radially outwards by a thicker zone belonging to the boss 446, through which an opening 457 passes, intended for the passage of a cold or hot heat-carrier fluid, respectively.

On viewing FIGS. 12 and 13 simultaneously, it is apparent that the plates 444 are stacked so that the sectors of the same type are superimposed. Thus, for example, all the cold heat-carrier sectors are exactly superimposed, and all the hot heat-carrier sectors are exactly superimposed. The openings 457 of the superimposed hot heat-carrier sectors together form a conduit parallel to the axis 413 for a hot heat-carrier fluid, and the openings 457 of the superimposed cold heat-carrier sectors together form a conduit parallel to the axis 413 for a cold heat-carrier fluid. Sealing means (not shown) are arranged between the plates 444, around the openings 457, in order to channel the heat-carrier fluids in a sealed manner in the conduits constituted by the aligned openings 457. At their ends, the above-mentioned conduits are connected in a sealed manner to inlet and outlet pipes 458 (FIG. 12) via corresponding apertures 459 passing through the enclosure 212, 312.

Given the continuous movement, always in the same direction, performed by the displacer rotor in this embodiment, it is no longer the same regeneration exchange surfaces that alternately provide regeneration heating and regeneration cooling. Conversely, there are regeneration cooling surfaces 16r that precede the cold heat-carrier surfaces 14b and regeneration heating surfaces 16c that precede the hot heat-carrier surfaces 14h.

In order to make the regeneration process more effective, each stage of regeneration is subdivided into two consecutive phases, namely an initial regeneration phase followed by a final regeneration phase. This feature is embodied by the presence of two consecutive regeneration sectors in each regeneration zone. More particularly, each heating regeneration zone comprises an initial heating regeneration sector 456ic followed by a final heating regeneration sector 456fc. Similarly, each cooling regeneration zone comprises an initial cooling regeneration sector 456ir followed by a final cooling regeneration sector 456fr.

Each initial heating regeneration sector 456ic, situated just behind a cold heat-carrier sector 454b, and each final cooling regeneration sector 456fr, situated just ahead of a cold heat-carrier sector 454b are cold regeneration sectors having in service substantially the same temperature Tgb closer to that of the cold heat-carrier sectors 454b than to that of the hot heat-carrier sectors 454h. It is possible for example to have Tgb≈Tb+(Th−Tb)/3.

Similarly, each initial cooling regeneration sector 456ir, situated just behind a hot heat-carrier sector 454h, and each final heating regeneration sector 456fc, situated just ahead of a hot heat-carrier sector 454h are hot regeneration sectors having in service substantially the same temperature Tgh closer to that of the hot heat-carrier sectors 454h than to that of the cold heat-carrier sectors 454b. It is possible for example to have Tgh≈Tb+2(Th−Tb)/3.

In the example shown, each heat-carrier sector 454 extends over 45° about the axis of rotation 413. Moreover, each initial 4561r or 456ic, or final 456fr or 456fc regeneration sector extends over 22.5° about the axis of rotation 413. Thus, each regeneration zone composed of an initial regeneration sector followed by a final regeneration sector extends over 45°. More generally, the angular range corresponding to a thermodynamic cycle, i.e. 180° in the example, is divided into four equal parts, respectively allocated to isothermal compression, isochoric heating by regeneration, isothermal expansion and isochoric cooling by regeneration.

According to an advantageous feature of the invention, the regeneration means operate by transfer of calories, more particularly transfer by conduction, in the circumferential direction between regeneration zones supplying calories (regeneration preceding a cold heat-carrier sector) and regeneration zones consuming calories (regeneration preceding a hot heat-carrier sector).

The cold regeneration sectors 456ic, 456fr situated on each side of a cold heat-carrier sector 454b are connected to each other in a single cold thermally conductive arch 460gb by a cold thermal bridge 461gb which extends radially outside the cold heat-carrier sector. The hot regeneration sectors 456ir, 456fc situated on each side of a hot heat-carrier sector 454h are connected to each other in a single hot thermally conductive arch 460gh by a hot thermal bridge 461gh which extends radially outside the hot heat-carrier sector. Thus, each heat-carrier sector 454 (454h or 454b) is externally straddled by an arch 460 (460gh or 460gb) comprising a pair of regeneration sectors linked by a thermal bridge. Each plate 444 is composed, for each angular range corresponding to a thermodynamic cycle, of two heat-carrier sectors and two arches.

The arches 460, and in particular their thermal bridge 461 (461gh or 461gb), act as a thermal reserve. It is advantageous for this thermal reserve to be relatively large so that in steady state the temperature of the regeneration sectors is relatively stable, i.e. the cyclical temperature variation is small each time a chamber passes in thermal contact with a regeneration sector. At the same time, when the arches 460 have a large heat capacity and a high thermal conductivity, the desired equality between the temperatures of the two regeneration sectors of the arch is better obtained in operation.

The heat-carrier sectors 454 (454h or 454b) must also have a good heat capacity and a good thermal conductivity so that the calories can be transferred between their heat-carrier exchange surfaces 14h or 14b on the one hand and the heat-carrier fluids on the other hand, with as small a temperature gradient as possible between the heat-carrier exchange surfaces and the heat-carrier fluids.

Thermal insulation 415, symbolized by double lines in FIG. 13, are provided at the separation between each heat-carrier element 454 and the arch 460 that straddles it, as well as between adjacent arches.

The embodiments shown in FIGS. 25 to 28 will be described only in respect of their differences in relation to the embodiment shown in FIG. 13.

In the example shown in FIG. 28, each fin is constituted of an alternation of cold 554b or hot 554h heat-carrier sectors between which are intercalated thermal containment sectors 556. For each angular range corresponding to a thermodynamic cycle, therefore each angular range of 180° in the example, the movement of the displacer then causes the gas to pass consecutively through a cold heat-carrier sector 554b, a thermal containment sector 556, a hot heat-carrier sector 554h, and a thermal containment sector 556. In the example shown, the sectors have a substantially identical angular range of 45°, the thermal containment sectors are linked together, straddling each heat-carrier sector on the inside.

On viewing FIGS. 28, 26 and 27 simultaneously, it is apparent that the heat-carrier sectors 554b, 554h are extended radially outwards by a thicker area belonging to the boss 546, passed through in a preferred embodiment by openings by 557e, 557s, for the input and outlet respectively of a heat-carrier fluid circulating in a network of channels 558 inside each heat-carrier sector. The circulation of the heat-carrier fluid within the heat-carrier sectors 554b, 554h has the advantage, in comparison with the circulation described with reference to FIG. 13, of promoting thermal exchanges between the heat-carrier fluid and the working gas. In this embodiment all the cold or respectively hot heat-carrier sectors are thermally in parallel between an inlet conduit constituted by the stacking of the openings 557e and two outlet conduits formed by the stacking of the pairs of outlet openings 557s. More generally, multiple heat-carrier elements are described, mounted thermally in parallel between at least one conduit of incoming heat-carrier fluid and at least one conduit of outgoing heat-carrier fluid.

According to the particularly preferred embodiment in FIG. 25, the fin 441 is constituted of an alternation in the circumferential direction of cold 654b or hot 654h heat-carrier sectors between which are intercalated regeneration sectors 656c, 656r and thermal containment sectors 655. For each angular range corresponding to a thermodynamic cycle, therefore each angular range of 180° in the example, the movement of the displacer 220 makes the working gas pass consecutively in contact with a cold heat-carrier sector 654b, a heating regeneration sector 656c, a thermal containment sector 655, a hot heat-carrier sector 654h, a cooling regeneration sector 656r, and a thermal containment sector 655. Moreover in the example shown, each sector extends over 30° about the axis of rotation 413.

Each heating regeneration sector 656c is linked with a cooling regenerator 656r by a thermal arch 660 that consecutively straddles a thermal containment sector 655 and a cold heat-carrier sector 654b, or (not shown) consecutively a thermal containment sector 655 and a hot heat-carrier sector 654h. It is also possible, (also not shown) to link all the regeneration sectors together by arches which together form an annulus. As a variant with respect to the embodiment in FIG. 13, the straddling arches are situated radially within the straddled sectors and no longer on the outside.

The heat-carrier sectors 654b, 654h are extended radially outwards by a thicker area belonging to the boss 646, passed through by openings 557e, 557s respectively for the input and outlet of a heat-carrier fluid circulating in a network of channels 558 inside each heat-carrier sector, substantially as for sectors 554b, 554h in FIG. 28.

With reference to FIGS. 15 to 22, the operation of the machine in FIGS. 11 to 14 will now be described, taking the example of the upper unit 201, and more particularly that of two diametrically opposed chambers 222. In the explanations below, it will be assumed fictitiously that each chamber 222 cooperates only with the exchange surfaces and the heat transfer means of a single plate, for the purposes of clarity and simplicity. It must however be absolutely clear that in reality, in this embodiment, each chamber is defined between two plates and cooperates thermally with the exchange surfaces and the heat transfer means of these two plates.

In the situation shown in FIG. 15, the two chambers are in thermal contact with the hot heat-carrier exchange sectors 454h while the piston 230 is at mid-stroke in the direction of enlargement of the working chamber 227. This is the isothermal expansion stage E3.

In the following FIGS. 16 to 22, the rotary displacer has rotated ⅛ cycle each time, therefore 1/16 rotation, i.e. 22.5°, in relation to the respectively previous figure.

In FIG. 16, half of the angular extent of each chamber 222 is still in contact with a hot heat-carrier sector 454h. The other half of each chamber 222 is in thermal contact with an initial cooling regeneration sector 456ir. This is the transition between the isothermal expansion stage E3 and the isochoric cooling stage E4. The power piston 230 approaches the end of its stroke, called “bottom dead centre”, for which the volume of the working chamber 227 is maximum. The gas contained in the chamber 222 gives up calories to the initial cooling regeneration sector 456ir. As indicated by the arrows H, these calories propagate in the hot thermal bridge 461gh then in the final heating regeneration sectors 456fc that are waiting further back for the following chamber to pass. It is apparent that this transfer of calories takes place in the opposite direction to the rotation of the rotor. At the same time, by giving up calories, the gas contained in the chamber 222 begins to cool.

In the situation shown in FIG. 17, the power piston 230 is at its bottom dead centre while each chamber 222 is in thermal contact with an initial cooling regeneration sector 456ir and a final cooling regeneration sector 456fr, which emit heat, respectively, toward the final heating regeneration sector 456fc situated upstream and the initial heating regeneration sector 4561c situated downstream (see the arrows H). This is the isochoric cooling stage E4.

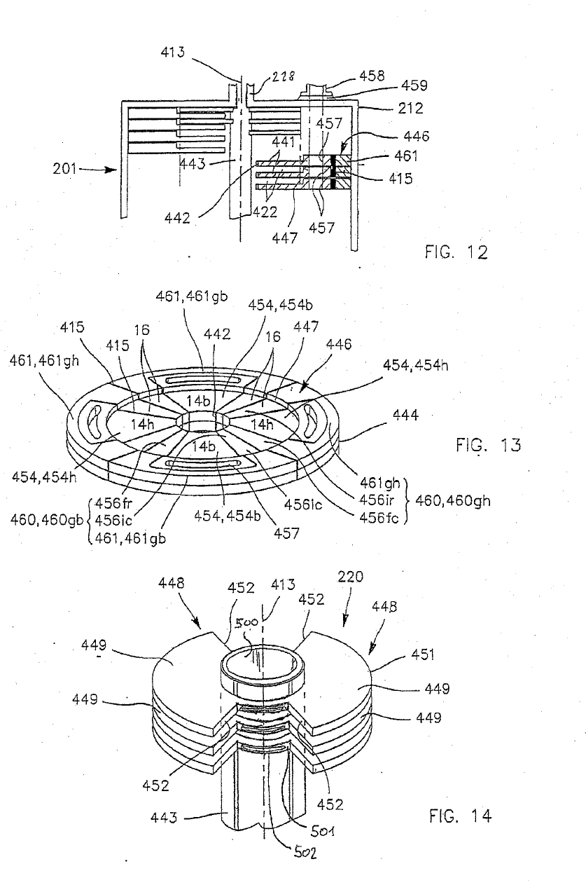

In FIG. 18, half of the angular extent of each chamber 222 has come into contact with a cold heat-carrier sector 454b. The other half of each chamber 222 is still in thermal contact with a final cooling regeneration sector 456fr. This is the transition between the isochoric cooling stage E4 and the isothermal compression stage E1. The power piston 230 starts to leave its bottom dead centre. The gas contained in the chamber 222 gives up calories to the final cooling regeneration sector 456fr. As indicated by the arrows H, these calories propagate in the cold thermal bridge 461gb then in the initial heating regeneration sectors 456ic situated downstream that are waiting for the subsequent passage of a chamber. This transfer of calories takes place in the direction of rotation of the rotor. At the same time, by giving up calories, the gas contained in the chamber 222 ends its cooling.

In the situation shown in FIG. 19, the two chambers are in thermal contact with the cold heat-carrier exchange sectors 454b while the power piston 230 is at mid-stroke in the direction of reduction of the volume of the working chamber 227. This is the isothermal compression stage E1.

In FIG. 20, half of the angular extent of each chamber 222 is still in contact with a cold heat-carrier sector 454b. The other half of each chamber 222 is in thermal contact with an initial heating regeneration sector 456ic. This is the transition between the isothermal compression stage E1 and the isochoric heating stage E2. The power piston 230 approaches of its end of stroke, called “top dead centre”, for which the volume of the working chamber 227 is minimum. The gas contained in the chamber 222 absorbs the calories supplied by the initial heating regeneration sector 456ic, originating from the associated cold thermal bridge 461gb, itself previously supplied with calories by the final cooling regeneration sector 456fr during the stages in FIGS. 17 and 18.

In the situation shown in FIG. 21, the power piston 230 is at its top dead centre while each chamber 222 is in thermal contact with an initial heating regeneration sector 456ic and a final heating regeneration sector 456fc, supplied with heat, respectively, by the final cooling regeneration sector 456fr situated upstream and the initial cooling regeneration sector 456fr situated downstream (see the arrows H). This is the isochoric heating stage E2.

In FIG. 22, half of the angular extent of each chamber 222 has come into contact with a hot heat-carrier sector 454h. The other half of each chamber 222 is still in thermal contact with a final heating regeneration sector 456fc. This is the transition between the isochoric heating stage E2 and the isothermal expansion stage E3. The power piston 230 starts to leave its top dead centre. The gas contained in the chamber 222 takes calories from the final heating regeneration sector 456fc, itself supplied with calories by the hot thermal bridge 461gh, and via the latter by the initial cooling regeneration sector situated downstream.

Then, the cycle starts again with isothermal expansion as described with reference to FIG. 15.

Thus, in operation, the thermal bridges perform a deferred heat transfer: one of the two regeneration sectors linked to each bridge receives calories from the gas when the chamber is in thermal contact with this sector, then the second regeneration sector receiving the calories via the bridge, gives them back a little later, either further on in the same chamber (in the case of a cold arch), or backwards to the following chamber (in the case of a hot arch).

The operation has been described from the standpoint of the transfer of calories. It is also possible to think in terms of the transfer of frigories, which always takes place in the opposite direction to the transfer of the calories. In this case, the frigories are transferred to the same chamber in the direction of rotation of the rotor via a hot thermal bridge, and in the opposite direction to the rotation of the rotor via a cold thermal bridge.

Moreover, the machine can operate as a heat pump (intended to heat the hot heat-carrier fluid) or as a refrigerating machine (intended to cool the cold heat-carrier fluid). To this end it is sufficient to reverse the cold and hot heat-carrier elements so that the isothermal expansion takes place at a low temperature and the isothermal compression at a high temperature. The same result is obtained by not reversing the cold and hot heat-carrier elements, but by offsetting the crankshaft 429 or the displacer rotor 220 by a semi-cycle i.e. in the example by offsetting the crankshaft by 180° and leaving the displacer rotor in an unchanged position in each of FIGS. 15 to 22, or also by offsetting the rotor by 90° and by leaving the crankshaft in an unchanged position in each of the FIGS. 15 to 22.

The operation of the machine in FIGS. 25 to 27 will now be described with joint reference to FIG. 31.

When the two chambers are in thermal contact with the hot heat-carrier exchange sectors 554h, the piston acts in the direction of an increase of the working chamber. The volume of the working gas increases, this is the isothermal expansion stage E7.

When the two chambers are in contact with the thermal containment sectors 556, the piston acts in the direction of a rapid increase in the working chamber, the volume of the working gas increases rapidly. This is the adiabatic expansion stage E8.

When the two chambers are in thermal contact with the cold heat-carrier exchange sectors 554b, the piston acts in the direction of a reduction of the working chamber. The volume of the working gas decreases, this is the isothermal compression stage E5.

When the two chambers are in contact with the thermal containment sectors 556, the piston acts in the direction of a rapid reduction in the working chamber, the volume of the working gas decreases rapidly. This is the adiabatic compression stage E6.

With reference to FIG. 31, the thermodynamic cycle described corresponds to a Carnot cycle. The theoretical yield of the Carnot cycle is equal to the theoretical yield of the Stirling cycle described previously. As transfers by thermal conduction are not very efficient when there are small thermal gradients between the hot reservoir and the cold reservoir, the actual yield of the Carnot cycle can be greater than the actual yield of the Stirling cycle when the temperature gradient is small. Moreover the thermodynamic Carnot cycle can be run more rapidly than the Stirling cycle as the thermal transfers of the Stirling cycle can be lengthy. Conversely, for large thermal gradients, the Carnot cycle requires significant variations in volume that are difficult to implement. For this reason the Stirling cycle is particularly preferred when there are large temperature gradients.

This is why, particularly preferentially, the motor according to the invention implements a hybrid Carnot-Stirling cycle. The operation of the machine in FIG. 28 will now be described with joint reference to FIGS. 32, 33.

When the two chambers are in thermal contact with the hot heat-carrier transfer sectors 654h, the piston acts in the direction of an increase in the working chamber. The volume of the working gas increases, this is the isothermal expansion stage E12.

When the two chambers are in thermal contact with the cooling regeneration sectors 656r, the power piston 230 is substantially stationary, therefore the volume of the working chamber is substantially constant. The gas contained in the chamber 222 gives up calories to the cooling regeneration sector 656f. The working gas then drops to a temperature T2 greater than the temperature T1 of the cold heat-carrier exchange sector 654b. This is the isochoric cooling stage E13.

When the two chambers are in contact with the thermal containment sectors 655 while the piston acts in the direction of a rapid increase in the size of the working chamber, the volume of the working gas increases rapidly. The temperature of the working gas decreases to the value T1 while the piston reaches its bottom dead centre. This is the adiabatic expansion stage E14.

When the two chambers are in thermal contact with the cold heat-carrier exchange sectors 654b, the piston acts in the direction of a reduction in the volume of the working chamber. The volume of the working gas decreases, this is the isothermal compression stage E9.

When the two chambers are in thermal contact with the heating regeneration sectors 656c, the power piston 230 is substantially stationary, therefore the volume of the working chamber is substantially constant. The gas contained in the chamber 222 takes up calories from the cooling regeneration sector 656r. The working gas then rises to a temperature T3 less than the temperature T4 of the hot heat-carrier exchange sector 654h. This is the isochoric heating stage E10.

When the two chambers are in contact with the thermal containment sectors 655, while the piston acts in the direction of a rapid reduction in the volume of the working chamber, the volume of the working gas decreases rapidly. The temperature of the working gas increases to the value T4 while the piston reaches its top dead centre. This is the adiabatic compression stage E11.

The embodiment shown in FIG. 23 will be described only with respect to its differences in relation to the embodiment in FIG. 11. Between the power crankshaft 429 and the drive pinion 471 of the gear 425 coupling the shaft 420 of the displacer to the crankshaft 429, a gear 472 is intercalated, the toothed wheels of which are non-circular. In the example shown, the toothed wheels are oval so as, in a Stirling cycle, to increase the speed of rotation of the crankshaft 429 when the pistons 230 and 330 are close to their mid-stroke, and in order to reduce the speed of rotation of the crankshaft 429 when the pistons 230, 330 are close to their top and bottom dead centres. The crankshaft 429 drives the output shaft 470 of the machine by means of the gear 472. Thus, the moment of inertia of the load regularizes the rotation of the displacer and imposes an irregular rotation, as described above, on the crankshaft 429. This irregular rotation has the effect of minimizing the variations in the volume of gas during the heating and cooling stages, in order to make them more similar to the ideal isochoric stages of the cycle. As a result, the majority of the volume variations occur during compression and expansion. Similarly, the toothed wheels can be substantially elliptical for a Carnot cycle but angularly offset in a manner appropriate to the speed variations described previously. In a manner that is not shown, the pinion can have a more complicated shape, by adapting the ratio of the diameters of the toothed wheels in order to obtain at all times the piston speed corresponding to the thermodynamic stage of the machine, in particular for the Carnot-Stirling cycle.

Other known mechanisms make it possible to obtain a similar effect. For example, a crankshaft comprising two crank pins angularly offset by for example 30°. The mechanism also comprises for each piston, two connecting rods each articulated by one of its ends to one of the crank pins respectively, and by its other end to a respective end of a cross-bar, the central axis of which is articulated to the piston.

FIG. 24 shows the implementation of a machine according to FIGS. 11 to 23 and 25 to 28 operating as a motor using as a hot reservoir the chiller 473 of a steam turbine 474. The drive shaft 476 of the turbine drives an electricity generator 477. In this installation, the steam cooled in the chiller 473 is compressed by a compressor 478, heated in a boiler 479, typically heated by the heat from the combustion of a fuel. The steam is then sent to the high pressure inlet 481 of the turbine 474. The steam expands in the turbine 474 then escapes through the low pressure outlet 483 in order to be sent to the steam path 484 of the chiller 473. The steam path 484 is in a heat exchange relationship with a heat-carrier circuit 486 containing a fluid of a suitable type and pressure taking account in particular of the temperature of the steam at the low pressure outlet 483 of the turbine. The heat-carrier fluid is kept in circulation by a pump 487. At the outlet of the chiller 473, the fluid is sent through the hot heat-carrier sectors 454h of the units 201 and 301 of the machine in FIGS. 11 to 23. With reference to FIG. 12, the heat-carrier fluid passes through the openings 457, the apertures 459 and channels 458. After passing through the hot heat-carrier sectors, the heat-carrier fluid returns to the cold intake of the chiller 473.

In a manner that is not shown, the installation also comprises a cold heat-carrier circuit, passing through the cold heat-carrier sectors of the units 201 and 301, and connected to a cold reservoir such as for example an evaporator or a watercourse. In a further manner that is not shown, the power shaft 429 of the machine according to the invention can be coupled to the drive shaft 476 of the turbine 474, in order to add its power to that of the turbine, or also be coupled to another electricity generator, or also to another payload.

A machine according to the invention can be realized in very numerous versions, according to its power and the temperature of the reservoirs in particular.

The machine given as an example in FIGS. 11 to 23 and 25 to 28 is envisaged for large scale implementations, the units 201 and 301 having for example a diameter of a few metres, and also an axial length of a few metres. The fins 441 can have a thickness of a few millimetres, comprised for example between 5 and 10 mm, similarly to the chambers 422 and the flanges 449 of the displacer rotor 220. The heat-carrier sectors and the arches of the stator plates can be made of metal. If the temperature of the hot reservoir is sufficiently moderate, the displacer rotor can be made of a synthetic material. A metal core 443 can also be envisaged on which synthetic flanges 449 could be fixed. The volume swept by the working piston with respect to the total volume of gas swept by the machine depends on the temperatures.

While the known machines of the Stirling type in general only deliver yields that are much lower than the theoretical yield of the Stirling cycle, and only when these known machines rotate at a very slow speed and with a relatively large temperature difference between the hot reservoir and the cold reservoir, it has been found that the machine according to the invention, in particular with an architecture of the type shown in FIGS. 11 to 24, is capable of delivering a yield close to the yield of its theoretical cycle, even with a relatively high rotation speed and a relatively small temperature difference, for example less than 100° C., between the hot reservoir and the cold reservoir.

Furthermore according to the invention an architecture has been found capable of delivering a yield close to the yield of the theoretical Carnot cycle, an architecture particularly adapted to small temperature differences between the hot reservoir and the cold reservoir.

Also according to the invention an architecture has been found allowing the combination of the Carnot and Stirling thermodynamic cycles capable, through a high yield and a high rotation speed, of delivering increased power in relation to the volume of the working chamber. In this cycle, the temperature range during isochoric cooling is on average higher than the temperature range during isochoric heating. Thus there is a gradient between the two that accelerates the conduction or other form of exchange between the regeneration surfaces. This allows for a faster operating speed. Thus in general terms a regeneration cycle has been designed in which the isochoric heating is carried out at a lower average temperature than the isochoric cooling.

Of course, the invention is not limited to the examples described and shown. In an embodiment having a rotary displacer, such as that in FIG. 11, a machine could be produced with a single enclosure or with more than two enclosures, and with a single cycle per rotation and per enclosure or more than two cycles per rotation and per enclosure.

It is also possible to envisage a machine equipped with several pistons, the capacity of which can be different, some generating the volume variations corresponding to the adiabatic phases, and the others generating the volume variations corresponding to the isothermal phases. Certain volume variations, in particular rapid variations, could be generated jointly by all of the pistons.

A machine can also be envisaged equipped with plates 444 stacked so that sectors of different types are superimposed, the plates capable of being different from each other, so as for example to homogenize the thermodynamic transformation time and reduce the variations in speed of the piston.

A machine can be envisaged operating according to the general principle of the embodiment in FIGS. 3 to 9, i.e. with a constant mass of gas in each chamber, but in which the rotary displacer could also provide volume variations.

1. A thermodynamic machine comprising:
an enclosure containing a working gas and having heat exchange surfaces therein;
displacement means moveable within the enclosure in order to displace the working gas in the enclosure and consecutively place the working gas in contact and out of contact with each of the heat exchange surfaces in order to perform consecutive stages of a thermodynamic cycle; and
a mechanical power unit subject to pressure of the working gas;
the displacement means configured for causing consecutive passage of a chamber in front of the different heat exchange surfaces, said chamber containing a quantity of working gas that is essentially constant, at least the majority of which is generally stationary in relation to the displacement means.

2. The machine according to claim 1, characterized in that the essentially constant quantity of working gas is an essentially constant volume.

3. The machine according to claim 1, characterized in that the chamber is delimited by two faces substantially opposite each other, integral with the displacement means.

4. The machine according to claim 1, characterized in that the displacement means include a rotor rotatable about an axis.

5. The machine according to claim 4, characterized in that the heat exchange surfaces occupy respective angular zones in the essentially cylindrical enclosure.

6. The machine according to claim 4, characterized in that the rotor comprises at least one lobe having the general shape of a partial cylinder rotating about the axis.

7. The machine according to claim 1, characterized by comprising thermal containment means capable of restricting the heat exchanges, and in that the displacement means place the working gas in contact with the thermal containment means during a movement of the power component, such that the thermodynamic cycle comprises at least one phase of adiabatic variation of the volume of the working gas.

8. The machine according to claim 1, characterized in that within the enclosure there is at least one thermal containment surface intercalated between the exchange surfaces.

9. The machine according to claim 7, characterized in that a thermodynamic cycle comprises passage of the gas in contact with the following surfaces:
a cold heat-carrier surface while the volume of the working gas decreases,
a thermal containment surface while the volume of the working gas decreases,
a hot heat-carrier surface while the volume of the working gas increases,
a thermal containment surface while the volume of the working gas increases.

10. The machine according to claim 9, characterized in that volume variation is more rapid while the working gas is in contact with the containment surfaces than while the gas is in contact with the heat-carrier exchange surfaces.

11. The machine according to, characterized by comprising means for regeneration of the working gas, which collect heat during a cooling phase of the working gas and heat the working gas during a phase of heating with the heat collected during the cooling phase, and/or which collect cold during a phase of heating the working gas and cool the working gas during a cooling phase with the cold collected during the heating phase, and in that the displacement means sweep the regeneration means so as to remove the working gas therefrom during at least one working phase of the compression and expansion phases forming part of the thermodynamic cycle.

12. The machine according to claim 1, characterized in that the exchange surfaces comprise along the path of the chamber, hot and cold heat-carrier exchange surfaces, and between these at least one regeneration exchange surface.

13. The machine according to claim 11, characterized in that it comprises a thermal containment surface intercalated between a regeneration surface situated upstream, in relation to the direction of displacement of the working gas, and a heat-carrier exchange surface situated downstream.

14. The machine according to claim 13, characterized in that when the working gas is in contact with a containment surface, a temperature variation is caused, by substantially adiabatic variation of the working gas, in the same direction as that undergone by the working gas on contact with the regeneration surface situated upstream.

15. The machine according to claim 14, characterized in that the substantially adiabatic volume variation is more rapid than a substantially isothermal variation performed while the working gas is in contact with the heat-carrier exchange surface.

16. The machine according to claim 13, characterized in that a thermodynamic cycle comprises passage of the gas in contact with the following surfaces:
a cold heat-carrier surface while the volume of the gas decreases;
a heating regeneration surface while the volume of the working gas is substantially constant;
a thermal containment surface while the volume of the working gas decreases;
a hot heat-carrier surface while the volume of the gas increases;
a cooling regeneration surface while the volume of the working gas is substantially constant; and
a thermal containment surface while the volume of the working gas increases.

17. The machine according to claim 12, characterized by heat transfer means between two regeneration exchange surfaces situated one at a transition between hot heat-carrier exchange surface and cold heat-carrier exchange surface, the other at a transition between cold heat-carrier exchange surface and hot heat-carrier exchange surface, in relation to the direction of movement of the chamber.

18. The machine according to claim 12, characterized in that
the enclosure bears between consecutive heat-carrier exchange surfaces an initial regeneration exchange surface followed, in relation to the direction of displacement of the chamber, by a final regeneration exchange surface;
initial and respectively final said regeneration exchange surfaces, situated at the outlet and inlet respectively of a cold heat-carrier exchange surface, are linked thermally to each other, and
initial and respectively final said regeneration exchange surfaces, situated at the outlet and inlet respectively of a cold heat-carrier exchange surface, are linked thermally to each other.

19. The machine according to claim 18, characterized in that the regeneration exchange surfaces that are linked thermally to each other form pairs assembled by thermal bridge externally and/or internally straddling a said heat-carrier exchange surface associated with the pair.

20. The machine according to claim 19, characterized by thermal insulation between the thermal bridge and the associated heat-carrier exchange surface.

21. The machine according to claim 17, characterized in that the heat transfer means operate by thermal conduction.

22. The machine according to claim 11, characterized in that the regeneration means include a thermal reserve which charges during a cooling phase of the gas and discharges during a heating phase of the gas.

23. The machine according to claim 1, characterized in that the consecutive exchange surfaces along the path of the chamber are separated by thermal insulation.

24. The machine according to claim 1, characterized in that the chamber has a flat shape, in that the heat exchange surfaces consecutively in contact with the working gas form two large opposite faces of the flat chamber, and the displacement means delimit the chamber by at least one narrow front face.

25. The machine according to claim 1, characterized in that the exchange surfaces belong to fins having faces parallel to a direction of movement of the displacement means in relation to the enclosure.

26. The machine according to claim 25, characterized in that the displacement means comprise flanges passing between the fins.

27. The machine according to claim 25, characterized in that the exchange surfaces are exhibited by a stack of plates each defining a fin and resting on each other by bosses, and in that the fins between them form for the displacement means passageways having a thickness defined by the bosses.

28. The machine according to claim 1, characterized by an absence of sealing means between the displacement means and the exchange surfaces, the pressure inside the enclosure being substantially equal at all times.

29. The machine according to claim 1, characterized in that the enclosure communicates with a working chamber in which the mechanical power unit is located.

30. The machine according to claim 1, characterized in that the displacement means substantially fill the free volume within the enclosure with the exception of the at least one chamber.

31. The machine according to claim 1, characterized in that this machine is a motor, in that the heat exchange surfaces comprise at least one hot heat-carrier exchange surface supplied with calorific energy from a hot reservoir while the mechanical power unit provides useful mechanical work.

32. The machine according to claim 23, characterized in that the calorific energy feeding the hot reservoir is residual energy provided by another thermal motor machine, in particular using a fuel.

33. The machine according to claim 1, characterized in that this machine is a refrigerating machine or a heat pump in which the heat exchange surfaces include a hot heat-carrier exchange surface and a cold heat-carrier exchange surface, and in that the mechanical power unit absorbs mechanical energy so that the compressed working gas supplies heat to the hot heat-carrier exchange surface and the expanded gas is heated by the cold heat-carrier exchange surface.

34. A method for the transformation of energy between the thermal form and the mechanical form, comprising: during a thermodynamic cycle thermal energy is taken from a working gas during an isochoric cooling and this thermal energy is supplied to the working gas during an isochoric heating, the isochoric cooling and/or the isochoric heating is adjacent on the one side to a substantially adiabatic variation in the volume of the working gas and on the other side to a substantially isothermal variation in the volume of the working gas.
